(19) United States
(12) Patent Application Publication
(10) Pub. No.: US 2024/0391338 A1
(43) Pub. Date: Nov. 28, 2024

(54) METHOD OF LIFTING MATERIALS ON A MINING RAMP USING A BATTERY POWERED TRANSPORT VEHICLE

(71) Applicants: Pivot Electric Machine Corp., Vancouver (CA); Prairie Machine & Parts Mfg. - Partnership, Saskatoon (CA)

(72) Inventors: William Hughes, Saskatoon (CA); Dave Cote, Vanscoy (CA)

(21) Appl. No.: 18/672,258

(22) Filed: May 23, 2024

Related U.S. Application Data
(60) Provisional application No. 63/504,338, filed on May 25, 2023.

(51) Int. Cl. B60L 53/30; B60L 53/62; B60L 53/66

(52) U.S. Cl. CPC B60L 53/32; B60L 53/62; B60L 53/66; B60L 2200/36

(57) ABSTRACT

A method for lifting materials on a mining ramp uses a plurality of battery powered transport vehicles along an inclined ramp such that in a cycle of operation the vehicle moves from a loading location at the bottom to a discharge location at the top. Each of the vehicles includes a supply of energy in at least one battery for driving the vehicle. The battery contains only enough energy for one or at most two cycles of operation. A charging system is provided which can be at the bottom or the top for charging the battery for recharging after each cycle. Preferably the charging system is located at the bottom of the incline so that the battery is discharged during the upward incline and recharged during the decline.

This application claims the benefit under 35 USC 119 (e) of Provisional Application 63/504,338 filed May 25, 2023.

This invention relates to a method of lifting bulk materials on a mining ramp using a battery powered vehicle.

A novel method for operating battery electric equipment to hoist material is described herein, along with supporting technology.

### BACKGROUND OF THE INVENTION

In mining operations, it is often required to move massive amounts of material along a ramp to raise or lower the material from a source location to a different level for processing. This is typically carried out by large trucks having a transportation weight of material often more than 200 tons.

It is desirable to replace fossil fuel driven vehicles by battery power. However, battery powered electric haulage equipment must carry a large and heavy battery to provide enough power and energy to fulfil their function of lifting material out of a mine up a ramp. The power and energy required to hoist heavy loads is extreme so that the battery required can in many cases be sufficiently large to impact the load carrying capacity of the vehicle. This problem has reduced the implementation of battery powered trucks for this function.

### SUMMARY OF THE INVENTION

According to the invention there is provided a method for lifting materials on a mining ramp using a battery powered transport vehicle comprising:
transporting bulk materials in a plurality of transport vehicles along an inclined ramp from a first location to a second location where the ramp is inclined upwardly in one direction and declined in the other direction;
such that in a cycle of operation the vehicle moves from the first location to the second location and back to the first location so as to undergo one upward incline and one decline;
providing on each of the vehicles a supply of energy in at least one battery for driving the vehicle;
providing a charging system for charging said at least one battery;
wherein said at least one battery contains only enough energy for two or less cycles of operation.

That is as described herein, by installing a battery just large enough to operate for one or two load-haul-dump cycles, the problems of heavy weight and high cost are mitigated. However, the battery, charging system, and operating method must co-operate in a specific manner.

The novel operating system may include the following components:
—a—A small battery with enough capacity for one or two cycles,
—b—A battery with high charge and discharge rate,
c—A battery with a very long cycle life,
d—A battery with carefully arranged and sized internal cooling systems,
e—A charger that can supply power to the vehicle at high rates,
f—A charging system that can connect and disconnect quickly and remotely, and
g—An arrangement of battery models that can charge in series and discharge in parallel.
h—The battery contains enough energy for two load haul dump cycles of operation.

The battery is sized so that, at the bottom of the ramp, it can provide enough energy (kW-hr) to drive the fully loaded equipment up a ramp to the dump site. The battery capacity will take into consideration the regeneration of energy during the drive down the ramp. There is no need to use high energy density or high volumetric efficiency cell technology since there is capacity on most heavy mining equipment for a smaller battery.

Such a battery may have a capacity of between 400 to 900 KW-hrs and a mass of 10,000 to 20,000 kilograms which may only be a small proportion of the weight to be transported so that the battery weight might be of the order of 7 percent of the total load. Modifications to the heavy haul vehicle thus avoid any impacts to the pay load capacity.

Typically, the ramp length will be between 1000 and 3000 meters. However, it will be appreciated that the battery size for any particular application (vehicle and mine) will be selected to match the function and operation involved so as to optimize the capital efficiency and maximise return on investment.

Preferably the charging system is located at one of the first and second locations. However it can also be located along the path at a separate location.

Preferably the charging system is located at the second location at the bottom of the incline so that said at least one battery is discharged during the upward incline and recharged during the decline. However, the system may be reversed depending on the mining operation so that the charging occurs at the at the top. Many practical applications already have electrically driven shovels at the bottom of the ramp which provides a ready power source for charging.

In order to minimize the battery size, the battery is preferably selected so that it is substantially discharged at the top of the incline.

The charging of the battery is preferably at high power rates (two to four megawatts). The interconnection between the battery and off-board charging system involves an automatic detection, interlock, and breaker that does not require human intervention.

Thus, the battery charger is an externally located grid connected high power charger. It provides DC current to the connection system. The charger provides this current at high voltage to minimize the size and weight of the connector system. A wireless automated system installed in the truck and charger monitors the truck systems and enables the charger when the truck is ready to accept current.

For automatic operation with little operator involvement and safety the vehicle preferably includes a control wireless automated system which communicates with the charging system and monitors the systems and enables the charger when the vehicle is ready to accept current. The control system can operate so that the vehicle and charging system communicate to provide the appropriate amount of energy to the truck and when charging is complete the connector retracts and the operator is given a signal to continue driving.

To minimize operating time the vehicle is preferably recharged at the charging system while being loaded or unloaded. However, in some cases this may not be possible and hence the charging system can be separated from this function.

For efficient operation the battery and charging system preferably has a charge rate between two to four megawatts

The interconnect system thus involves an extensible connector system mounted on a station at the operator's level. When the truck drives into the charging station and is ready to accept charge the connector extends into a receptacle on the truck. The operator does not leave the cab nor does anyone outside the vehicle need to intervene. The truck and charging system then communicate and the charger provides the appropriate amount of power and energy to the truck. When charging is complete the connector retracts and the operator is given a signal to continue driving. The entire operation is typically completed in only a few minutes.

The amount of energy supplied to the battery is carefully managed so that the energy from the charger, plus the energy from the regeneration, will just be sufficient to allow the vehicle to complete the next duty cycle. In addition, the battery must be charged between two carefully chosen charge states, since batteries charged above a certain level, or below a certain level, have reduced capacity, charge rates, and service life.

Preferably the battery and charging system has a charge rate sufficient to recharge in less than 7 minutes.

The battery should thus be designed to charge and discharge rapidly. The vehicle's battery will be charged for each load-haul-dump cycle and this will reduce the efficiency of the equipment. Therefore, the time spent charging must be minimized as much as possible to improve the capital effectiveness of the equipment. Cell technology for the battery should be chosen to emphasize charge rate and thermal efficiency over energy density.

The battery preferably has a cooling system arranged to maintain the temperature at the optimum level so that the temperature rise during charging prevents any cell from rising above 45° C. Sustained cooling during the load-haul-dump cycle can be used to reduce the cell temperatures in preparation for the next charge cycle.

That is the battery will be operating at high charge and discharge rates (power). This results in heat losses internal to the cells. This heat must be removed by a cooling system. The cell technology chosen has high thermal efficiency to minimize the heat that must be transferred. In addition, the conductive cooling plates are preferably located on the transverse axis of the prismatic cells to maximize the rate of heat conduction. The plates are on the bottom of the cells (away from bus bars) to minimize any potential condensation issues. Lastly, the plates are directly cooled by embedded refrigerant cooling pipes. These pipes are installed with all fittings and connections external to the battery. Any leaks of refrigerant will generally be external to the battery. If a pipe cracks inside the battery, any refrigerant will flash to gas and not affect the bus-bars or cells.

Preferably in order to operate in the above system where repeated recharging is necessary, the battery is arranged and cell cathode chemistry is chosen so that it has a long cycle life greater than 40,000 cycles.

That is the battery will be charged and discharged many times during a given operating shift. The cell technology chosen for the battery must have as long a cycle life as practical. Using long cycle life cells will maximize the capital efficiency of the equipment. This also prevents issues with high operating costs and the impracticality of swapping batteries for rebuild and charging.

Preferably the battery has an arrangement of cells that can charge in series and discharge in parallel. That is the charging arrangement allows the batteries to be charged in series at a high voltage and low current scenario and discharged in parallel in a lower voltage high current scenario. This feature is attractive from the point of view that charging at higher voltage will allow for reduced current at a given power level. The charge phase of the cycle is the highest power operation required during the cycle and will benefit most from operation at high voltage. Discharging at lower voltage (between 800 to 1200 volts DC) will allow for components designed for existing mobile applications such as DC-DC converters and inverters for the traction motor. While this concept is desirable from a performance point of view it is not strictly required for the concept to be practical.

More particularly a novel arrangement of contacts and safety systems is provided. This arrangement allows the batteries to be charged in series at a high voltage and low current scenario and discharged in parallel in a lower voltage high current scenario. This allows the two systems (charging and discharging) to use equipment matched for the service conditions.

The equipment's battery preferably consists of dozens of independent modules. Each module's condition is monitored separately. The vehicle's onboard management system interconnects the modules as needed and with due consideration to the module's status. Therefore, one or more modules could be unserviceable for a short period, but the vehicle can still operate until the modules are repaired or replaced.

### BRIEF DESCRIPTION OF THE DRAWINGS

One embodiment of the invention will now be described in conjunction with the accompanying drawings in which:

FIG. 1 is a schematic illustration of a system or method for lifting materials on a mining ramp using a battery powered transport vehicle according to the present invention.

FIG. 2 is a schematic illustration of a vehicle for use in the method of FIG. 1.

FIG. 3 is a schematic illustration of a battery and cooling system for the cells for use in the method of FIG. 1.

FIG. 4 is a schematic illustration of a charging system for the cells of the battery for use in the method of FIG. 1.

FIG. 5 is an isometric view of a battery module containing the cooling system and cells for use in the method of FIG. 1.

FIG. 6 is an isometric view of a battery including four sub-modules each containing the cooling system and cells for use in the method of FIG. 1.

FIG. 7 is a schematic circuit diagram for the charging system of FIG. 4 for the cells of the battery for use in the method of FIG. 1.

FIGS. 8, 9 and 10 show schematic circuit diagrams of alternative arrangements for switching between the charging and discharging for the cells of the battery module for use in the method of FIG. 1.

FIG. 11 is an isometric view of a part only of the vehicle of FIG. 2 showing the location of the battery module and drive transmission.

FIG. 12 shows a further isometric view of the motor and the drive transmission of the vehicle of FIG. 2.

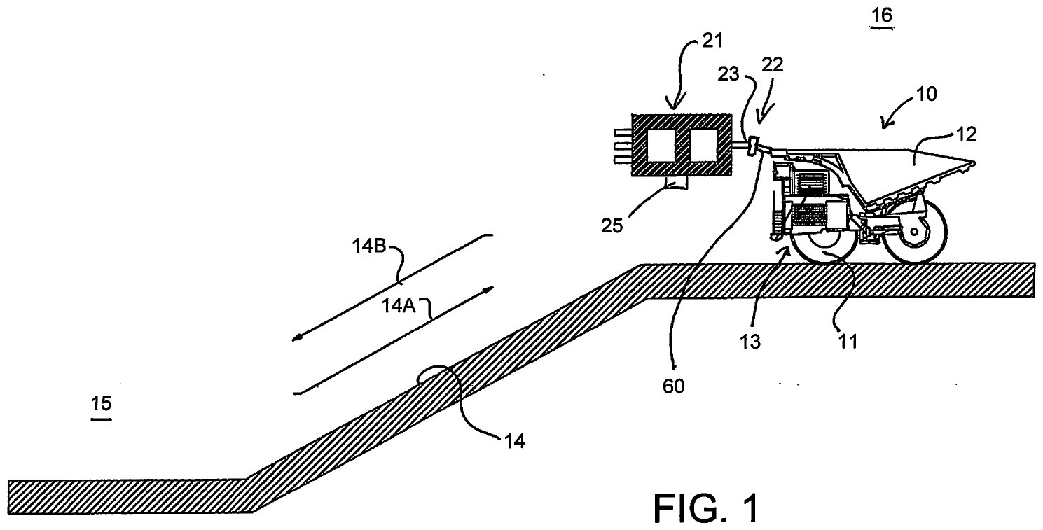

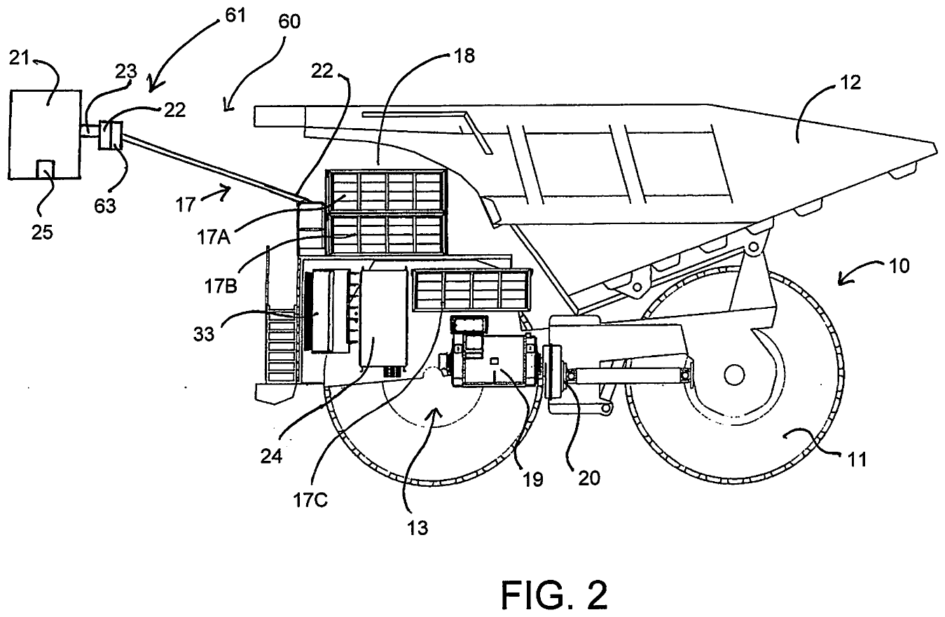

In the drawings like characters of reference indicate corresponding parts in the different figures.

### DETAILED DESCRIPTION

As shown in the figures there is provided a method for lifting materials on a mining ramp 14 using a battery powered transport vehicle 10 having ground wheels, 11, a pivotal dump container 12 for a large volume of bulk material and a drive system 13.

The vehicle is used for transporting bulk materials in a series of such transport vehicles along an inclined ramp 14 from a first location 15 to a second location 16. The ramp is inclined upwardly in one direction 14A and declined in the other direction 14B.

In a cycle of operation the vehicle 10 moves from the first location 15 at a loading zone for example in a mine to the second location 16 for discharge of the loaded material for processing and back to the first location 15 so as to undergo one upward incline and one decline. This can, as shown, have the upward incline first from the loading to the dump locations followed by a decline back to the loading zone. As shown in this example a charging system 21 for the on-board batteries is at the dump zone at the top of the incline but this arrangement may be reversed.

On each of the vehicles is provided a supply of energy in batteries 17 for driving the vehicle through an electric motor 19 and a transmission 20, of a conventional nature. As shown the batteries include separate modules 17A, 17B and 17C where the modules are located in the area forward of and below the dump box 12 with module 17C adjacent to and forward of the transmission and modules 17A and 17B above the first module and alongside the cab 18.

The charging system 21 for charging the battery on the vehicle is located at the dumping location 16 and includes a receptacle 22 on the vehicle which can be mated with a charging connector 23 on the charging system 21.

The interconnect system thus involves an extensible connector system 60 mounted on a station 61 at the operator's level. When the truck drives into the charging station and is ready to accept charge the connector 60 extends into the receptacle 22 on the truck. The interconnection between the battery and off-board charging system involves an automatic detection, interlock, and breaker generally indicated at 63 that does not require human intervention.

The batteries 17 on the vehicle are arranged so that in combination they contain only enough energy for two or less cycles of operation. The charging of the batteries 17 and the use of the energy to drive the transmission is controlled by a motor control center 24 on the vehicle 10.

Typically the batteries 17 contain only enough energy for just greater than one cycle so that the energy applied together with the energy generated by the recharge in the decline 14B is sufficient to enable the vehicle to make one incline 14A. Some additional energy must be included so as to avoid running out in the event of an interference in operation but typically the total is less than two cycles of operation.

The control center 24 acts as a control wireless automated system which communicates with the charging system 21 and monitors the systems and enables the charger 60 when the vehicle is ready to accept current. In this the way the vehicle and a control device 25 of the charging system communicate to provide the appropriate amount of energy to the truck and when charging is complete the connector 60 retracts and the operator is given a signal to continue driving.

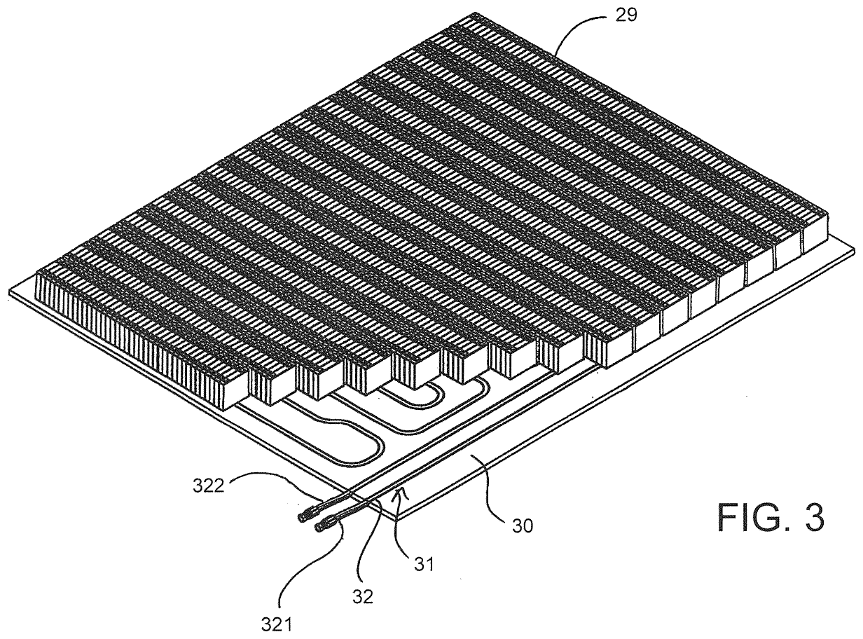

As shown in FIG. 3, the battery comprises an array of prismatic lithium ion cells 29 mounted on a base 30 that has a cooling system 31 defined by cooling lines 32 including an inlet 321 and an outlet 322 from a refrigeration cycle cooling system 33 on the vehicle. The cooling system is arranged to maintain the temperature of the cells at less than 45° C. during charging. Thus the cooling system includes for each module a conductive cooling plate 30 located on the transverse axis of the prismatic cells 29 to maximize the rate of heat conduction. The plates 30 are on the bottom of the cells away from bus bars (not shown) electrically connecting to the cells 29 to minimize any potential condensation issues at the bus bars. The plates 30 are directly cooled by the embedded or attached refrigerant cooling pipes 32.

The battery thus includes a cooling system 31 arranged to maintain the temperature at the optimum level so that the temperature rise during charging prevents any cell from rising above 45° C. Sustained cooling from the system 31 which is maintained during the load-haul-dump cycle reduces the temperatures of the cells 29 in preparation for the next charge cycle.

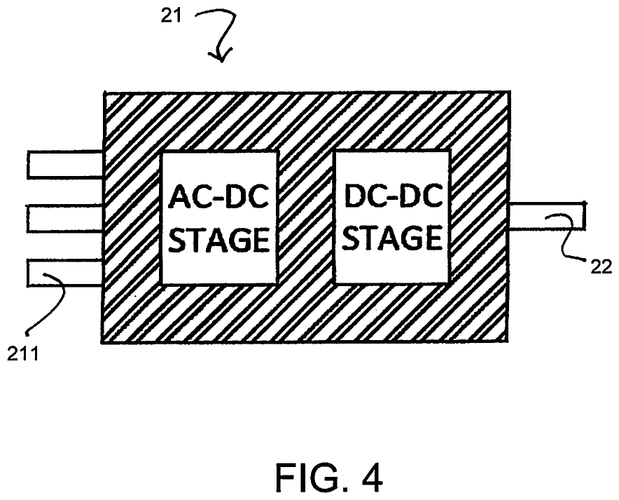

As shown in FIG. 4, the charging system 21 and battery modules 17 have an arrangement of cells 29 that can charge in series and discharge in parallel. The charging arrangement shown includes AC terminals 211 which allow the batteries to be charged in series at a voltage above 4000 volts DC and low current and discharged in parallel in a lower voltage (800 to 1200 volts DC) and high current.

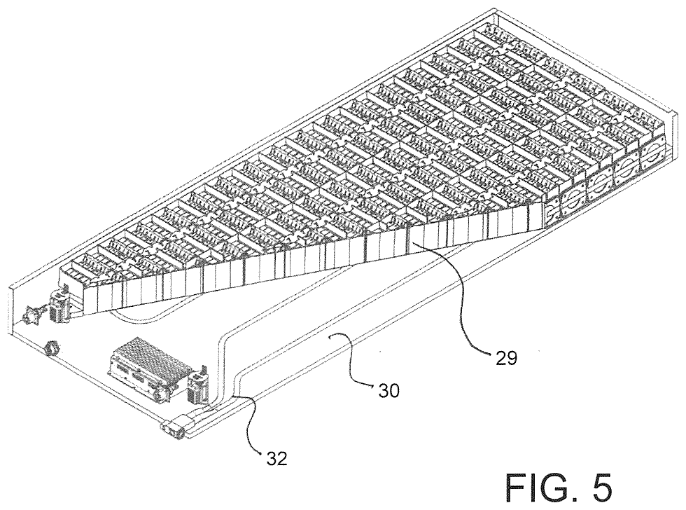

In FIG. 5 is shown a Battery Module 17 for mounting in the vehicle 10. The module has the following characteristics:
Up to 120 kWh module and more preferably around 30 kWh
Up to 1200V peak and 1000V nominal with more preferably 250 VDC nominal
120 Ah nominal capacity
Minimum 4 modules per vehicle
Maximum 10 modules per vehicle
Modules could be configured to charge in series or in parallel depending on charge system configuration and include B+ and B− connectors.

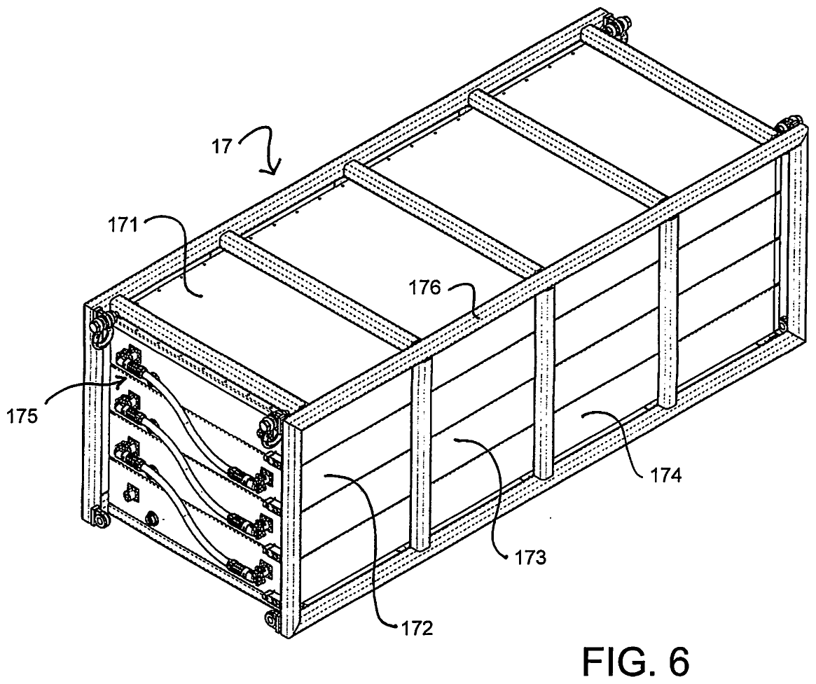

FIG. 6 is an isometric view of a battery including four sub-modules 171 to 174 mounted in a suitable rack or frame 176 and connected in series as shown at 175. This can be arranged to provide 1000 VDC nominal with 120 Ah with 120 kWh energy at 500 kW peak power. This assembly can include a weight of around 5000 lbs. the vehicle can be provided with up to 10 of these modules arranged in the locations 17A, 17B and 17C on the vehicle.

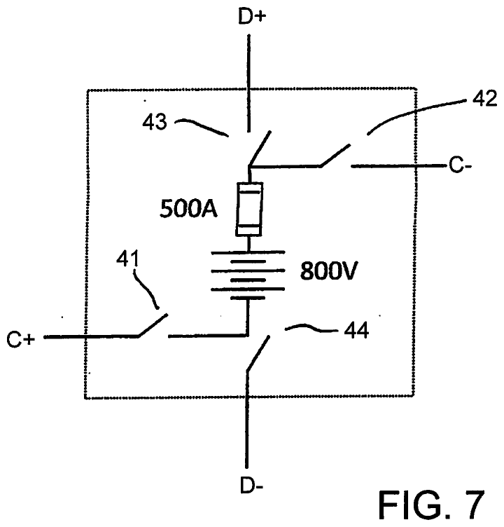

FIG. 7 shows the charging discharging circuit with switches 41 and 42 to connect the cells into the charging circuit C+ and C− and switches 43 and 44 to connect the cells into the discharge circuit D+ and D−.

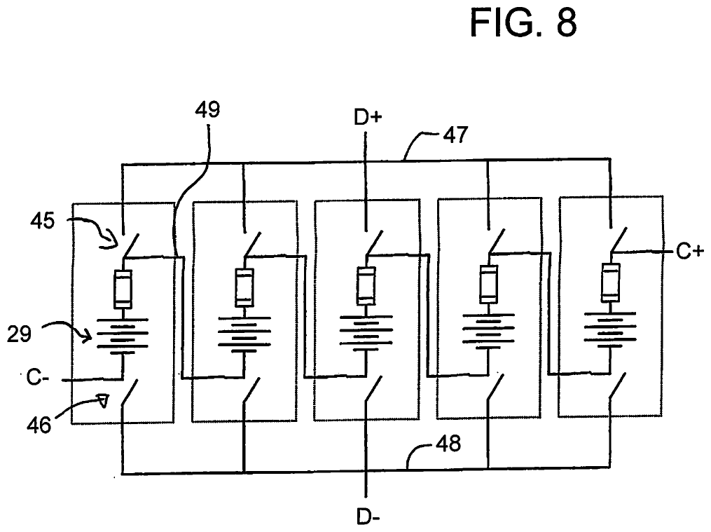

FIG. 8 shows the charging discharging circuit across the individual cells 29 with a series of switches 46 to connect the cells into the charging circuit C+ and C−, and a series of switches 45 to connect the cells into the discharge circuit D+ and D−. As can be seen by the circuit paths, the cells charge in series from one cell 29 to the next through the connectors 49 and discharge in parallel from the buses 47 and 48.

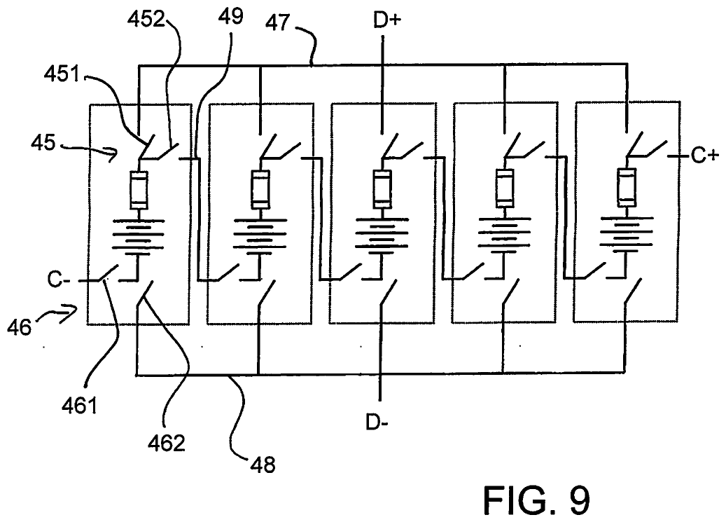

As shown in FIG. 9, the same arrangement of series charging and parallel discharging is used as in FIG. 8 but the switch arrangements 45 include further switch components 451 and 452 and the switch arrangements 46 include further switch components 461 and 462 to provide better isolation.

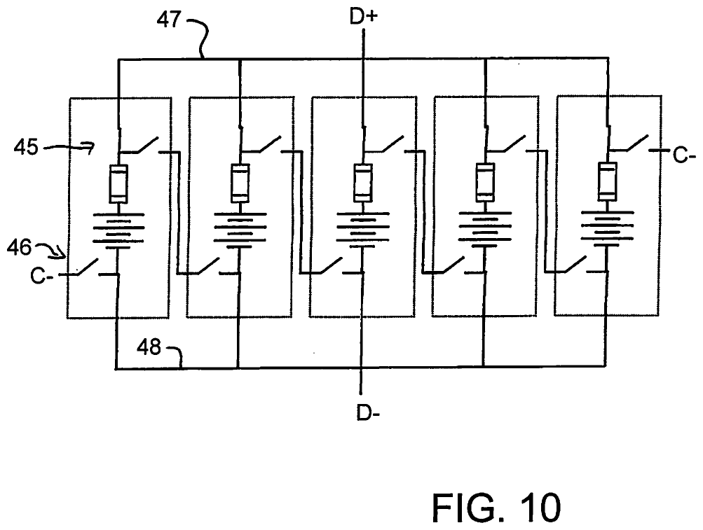

FIG. 10 shows a further possible arrangement of the switch elements 45 and 46.

As shown in FIGS. 8, 9 and 10, the slide deck shows 800V batteries that can be arranged in parallel for discharge and in series for charging. With 5 modules in this arrangement the charge voltage would go up to 4000V but would require ⅕th the current at a given charge power.

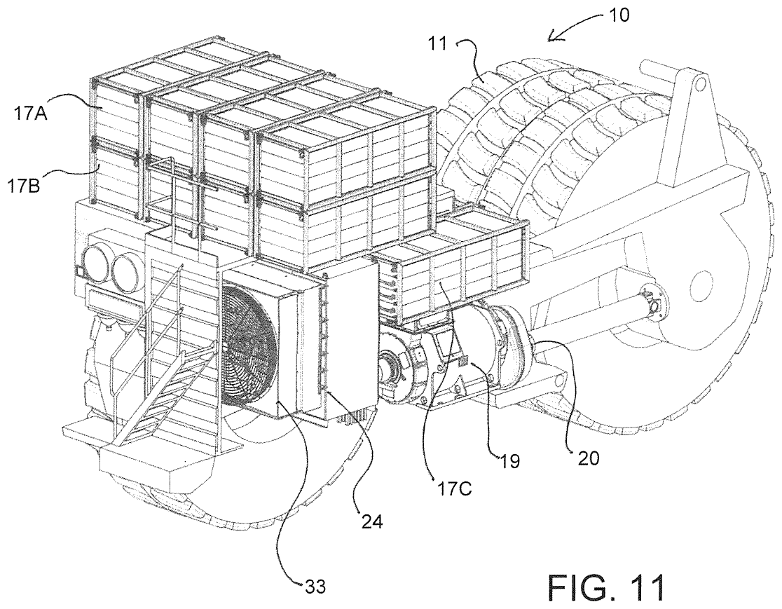

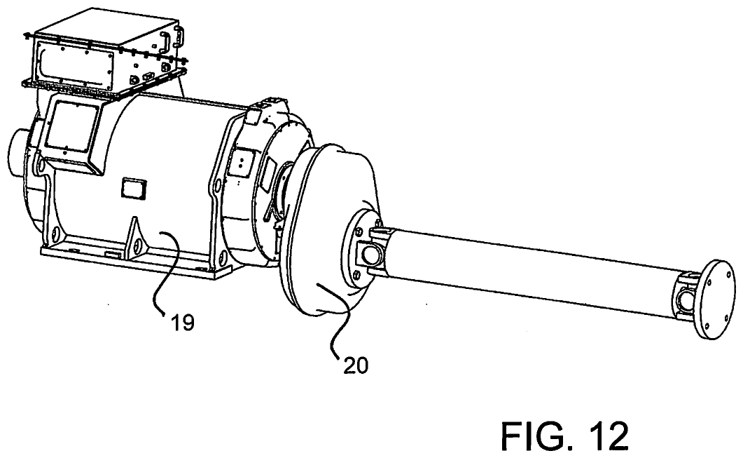

FIGS. 11 and 12 show an arrangement of the motors 50 and 51 driving in parallel a gear 52 of a transmission 53.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for lifting materials on a mining ramp using a battery powered transport vehicle comprising:
transporting bulk materials in a plurality of transport vehicles along an inclined ramp from a first location to a second location where the ramp is inclined upwardly in one direction and declined in the other direction;
such that in a cycle of operation the vehicle moves from the first location to the second location and back to the first location so as to undergo one upward incline and one decline;
providing on each of the vehicles a supply of energy in at least one battery for driving the vehicle;
providing a charging system for charging said at least one battery;
wherein said at least one battery contains only enough energy for two or less cycles of operation.

2. The method according to claim 1 wherein said at least one battery contains only enough energy for less than two cycles of operation.

3. The method according to claim 1 wherein the charging system is located at one of the first and second locations.

4. The method according to claim 1 wherein the charging system is located at the second location at the bottom of the incline so that said at least one battery is discharged during the upward incline and recharged during the decline.

5. The method according to claim 4 wherein said at least one battery is substantially discharged at the top of the incline.

6. The method according to claim 1 wherein the charging system includes movable engaging elements for connecting the charger and a receptacle mounted on the vehicle.

7. The method according to claim 6 wherein the interconnection between the battery and the charger includes an automatic detection, interlock, and breaker that does not require human intervention.

8. The method according to claim 6 wherein the vehicle includes a wireless automated control system which communicates with the charging system and monitors the systems and enables the charger when the vehicle is ready to accept current.

9. The method according to claim 6 wherein the vehicle and charging system communicate to provide the appropriate amount of energy to the vehicle and when charging is complete the connector retracts and the operator is given a signal to continue driving.

10. The method according to any preceding claim wherein the vehicle is recharged at the charging system while being loaded or unloaded.

11. The method according to claim 1 wherein said at least one battery and charging system has a charge rate in the range 2 to 4 megawatts.

12. The method according to claim 1 wherein said at least one battery and charging system has a charge rate sufficient to recharge in less than 7 minutes.

13. The method according to claim 1 wherein said at least one battery has a cooling system arranged to maintain the temperature of any one of the cells to less than 45° C. during said charging.

14. The method according to claim 1 wherein cooling is maintained during the cycle and acts to reduce the cell temperatures in preparation for the next charging.

15. The method according to claim 13 wherein the cooling system includes conductive cooling plates located on a transverse axis of prismatic cells to maximize the rate of heat conduction wherein the cooling plates are on the bottom of the cells (away from bus bars) to minimize any potential condensation issues and wherein the plates are directly cooled by embedded refrigerant cooling pipes.

16. The method according to claim 1 wherein said at least one battery has a capacity of between 400 to 900 KW-hrs, a mass of mass in of the order of 10,000 to 20,000 kilograms and a long cycle life greater than 40,000 cycles.

17. The method according to claim 1 wherein said at least one battery has an arrangement of cells that can charge in series and discharge in parallel.

18. The method according to claim 17 wherein the charging arrangement allows the batteries to be charged in series at a voltage above 4000 volts DC and low current scenario and discharged in parallel in a lower voltage in the range 800 to 1200 volts DC at a high current.

19. The method according to claim 18 wherein there is provided a battery controller which interconnects at least two battery sub-modules so as to support charging one or more battery sub-modules in series and discharging one or more battery sub-modules in parallel.

20. The method according to claim 19 wherein the battery controller connects or disconnects the battery sub-modules during operation to maintain an optimum state of charge across all battery sub-modules.
